(19) United States
(12) Patent Application Publication
(10) Pub. No.: US 2008/0091420 A1
(43) Pub. Date: Apr. 17, 2008

(54) APPARATUS AND METHOD FOR REPRODUCING AUDIO DATA

(75) Inventor: Tsung-Jen Chuang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/627,347

(22) Filed: Jan. 25, 2007

(30) Foreign Application Priority Data
Oct. 13, 2006 (CN) 200610063088.7

(51) Int. Cl. G10L 21/00

(52) U.S. Cl. 704/225

(57) ABSTRACT

An apparatus is used for reproducing digitized and compressed encoded audio data from a portable audio storage device. The apparatus includes a data reader, a processor, a volume adjusting module, and an output module. The data reader is for reproducing compressed encoded audio signals of the digitized and compressed encoded audio data. The input module is for receiving the compressed encoded audio signals. The processor is for processing the compressed encoded audio signal with a sound effect processing technology. The volume adjusting module for adjusting volume of the processed audio signal. The output module is for outputting the processed audio signal to an earphone.

### BACKGROUND OF THE INVENTION

1. Field of the Invention

The present invention generally relates to apparatuses and methods for reproducing audio data, and particularly to an apparatus and a method for reproducing digitized and compressed encoded audio data from a portable audio storage device.

2. Description of Related Art

Today, portable audio signal reproducing apparatuses, in which audio signals may be heard by headphones, have become popular to provide for a more extensive range of appreciation of music or the like.

Generally, these portable audio reproducing apparatuses are small in size and a reduced size and weight have made it more popular. Thus, a small receiving space is defined in a portable audio reproducing apparatus for accommodating a semiconductor memory used for storing the audio signals. However, a data capacity of a small-sized memory is limited, thus, leading to a demand for high efficiency compression encoding of the audio signals. There are many compression technologies for the audio signals, such as MP3, WMA (windows media audio), RM (real media), and AAC (advanced audio coding), but a lot of data in the audio signals may be lost by using most of these compression technologies, e.g. MP3. Data lost reduces a tone quality of audio signals reproduced by the audio reproducing apparatus.

Therefore, an apparatus and a method for reproducing digitized and compressed encoded audio data from a portable audio storage device with a high tone quality are needed in the industry to address the aforementioned deficiencies and inadequacies.

### SUMMARY OF THE INVENTION

An apparatus is used for reproducing digitized and compressed encoded audio data from a portable audio storage device. The apparatus includes a data reader, a processor, a volume adjusting module, and an output module. The data reader is for reproducing compressed encoded audio signals of the digitized and compressed encoded audio data. The input module is for receiving the compressed encoded audio signals. The processor is for processing the compressed encoded audio signal with a sound effect processing technology. The volume adjusting module for adjusting volume of the processed audio signal. The output module is for outputting the processed audio signal to an earphone. A method for processing audio signal in the portable audio device is also disclosed.

Other systems, methods, features, and advantages of the present variable apparatus and a method will be or become apparent to one with skill in the art upon examination of the following drawings and detailed description. It is intended that all such additional systems, methods, features, and advantages be included within this description, be within the scope of the present device, and be protected by the accompanying claims.

### BRIEF DESCRIPTION OF THE DRAWINGS

Many aspects of the present apparatus and the present method can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a block diagram showing a portable audio reproducing system with an apparatus for reproducing audio signal in accordance with a exemplary embodiment;

FIG. 2 is a block diagram illustrating the portable audio reproducing system of FIG. 1; and

FIG. 3 is a flowchart illustrating a method for reproducing audio signal in accordance with an exemplary embodiment.

### DETAILED DESCRIPTION OF THE INVENTION

Reference will now be made to the drawings to describe a preferred embodiment of the present apparatus and a preferred embodiment of the present method.

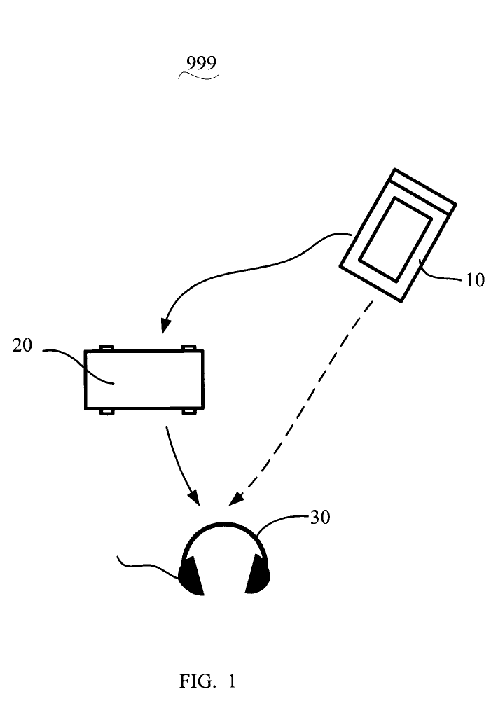

Referring to FIG. 1, a portable audio reproducing system 999 in accordance with an exemplary embodiment is illustrated. The portable audio reproducing system 999 includes a data reader 10, an apparatus 20, and an earphone 30.

The data reader 10 includes a semiconductor memory (not shown) for storing digitized and compressed encoded audio data. The data reader 10 can reproduce the compressed encoded audio data, thus yielding reproduced compressed encoded audio signals. An MP3/MP4 player, a mobile phone, or the like may act as the data reader 10 in this embodiment.

The apparatus 20 communicates with the data reader 10 via a wired or wireless connection and is configured for receiving the reproduced compressed encoded audio signals from the data reader 10. The apparatus 20 stores sound effect processing technology related programs, such as BBE, Dolby, so that the apparatus 20 can process the audio signals with one or more sound effect processing technology, thus compensating lost data in the compressed encoded audio signals. The compensated audio signals are of a higher quality, and are converted into audible sound by the earphone 30.

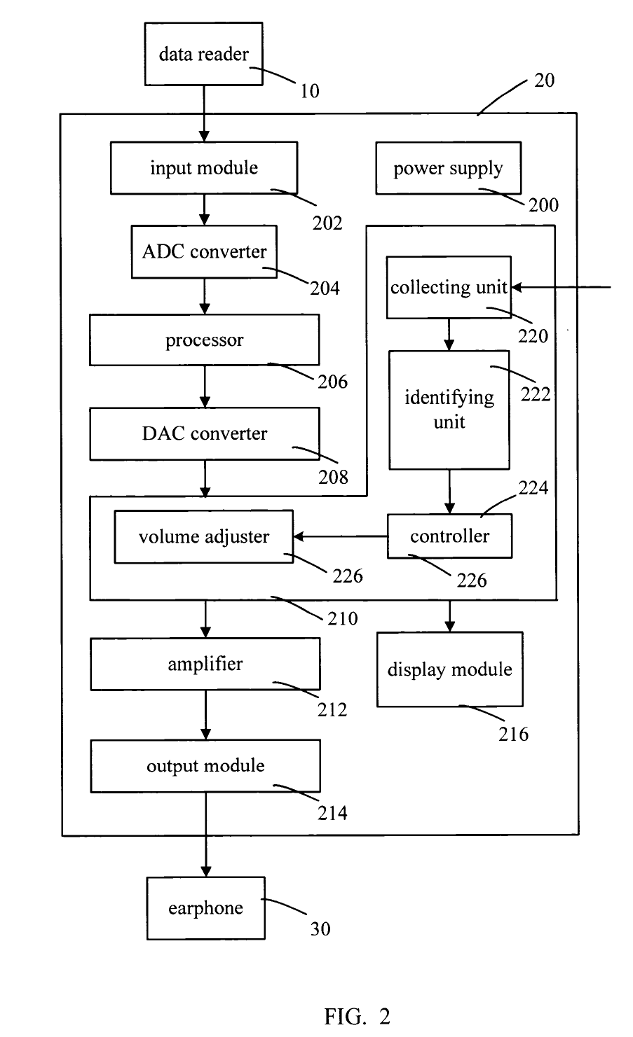

Referring to FIG. 2, the apparatus 20 includes a power supply 200, an input module 202, an analog-to-digital converter (ADC) 204, a processor 206, a digital-to-analog converter (DAC) 208, a volume adjusting module 210, an output module 214, and a display module 216.

The power supply 200 is used for providing power for all components among the apparatus 20. The power supply 200 can be a dry battery or a storage battery. The input module 202 is for receiving the reproduced audio signals from the data reader 10. The ADC 204 is for converting the reproduced audio signal from an analog format into a digital format. The processor 206 is for processing the digital audio signal with the sound effect processing technology, such as the BBE technology. The DAC 208 is for converting the digital audio signal processed by the processor 206 into an analog audio signal. The volume adjusting module 210 is for adjusting a volume of the analog audio signal from the DAC 208. The amplifier 212 is for amplifying the analog audio signal from the volume adjusting module. The output module 214 is for outputting the analog audio signal from the volume adjusting module to the earphone 30. The display module 216 is for displaying some data of the audio signal, such as names of songs, volume.

The volume adjusting module 210 includes a collecting unit 220, an identifying unit 222, a controller 224, and a volume adjuster 226. The collecting unit 220 is for collecting sound waves of various environments where the portable audio reproducing apparatus is located. The identifying unit 222 is for identifying a volume of the sound waves. The controller 224 is for generating a volume adjusting signal based on the volume of the sound waves, and using the volume adjusting signal to control the volume adjuster 226 to adjust volume of the analog audio signal.

Therefore, the portable audio reproducing apparatus can output the audible sound with optimal volume wherever the portable audio reproducing apparatus is located.

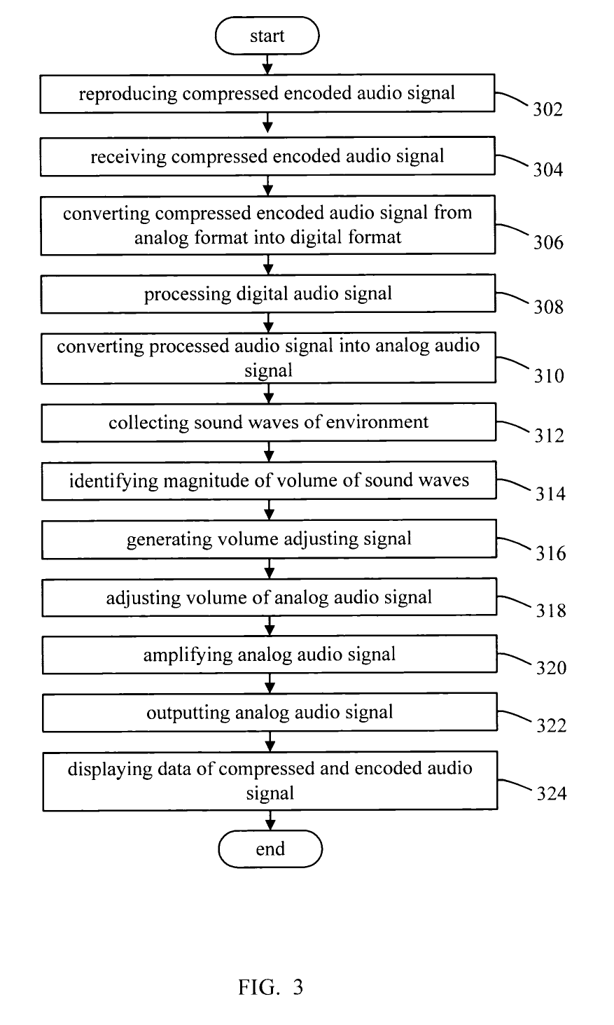

Referring to FIG. 3, a procedure of a method for reproducing digitized and compressed encoded audio data from a portable audio storage device in accordance with an exemplary embodiment is illustrated.

Step 302, the data reader 10 reproduces the compressed encoded audio signals.

Step 304, the input module 202 receives the compressed encoded audio signals from the data reader 10.

Step 306, the ADC 204 converts the compressed encoded audio signals from the analog format into the digital format.

Step 308, the processor 206 processes the digital compressed encoded audio signal with one or more programs related to sound effect processing technologies, such as a BBE technology.

Step 310, the DAC 208 converts the processed digital audio signals into analog audio signals.

Step 312, the collecting unit 220 collects sound waves of an environment where the portable audio storage device is located.

Step 314, the identifying unit 222 identifies the volume of the sound waves.

Step 316, the controller 224 generates the volume adjusting signal based on the volume of the sound waves.

Step 318, the volume adjuster 226 adjusts the volume of the analog audio signals based on the volume adjusting signal.

Step 320, the amplifier 212 amplifies the analog audio signals.

Step 322, the output module 214 outputs the analog audio signals to the earphone 10.

Step 324, the display module 216 displays the data of the compressed encoded audio signals.

It should be emphasized that the above-described preferred embodiment, is merely a possible example of implementation of the principles of the invention, and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and be protected by the following claims.

What is claimed is:

1. An apparatus for reproducing digitized and compressed encoded audio data from a portable audio storage device comprising:
an input module for receiving a compressed encoded audio signals from the digitized and compressed encoded audio data;
a processor for processing the compressed encoded audio signal with a sound effect processing technology;
a volume adjusting module for adjusting volume of the processed audio signal; and
an output module for outputting the processed audio signal to an earphone.

2. The apparatus according to claim 1, wherein the volume adjusting module comprises a collecting unit for collecting sound waves of various environments where the portable audio reproducing apparatus is located, an identifying unit for identifying volume of the sound waves, a volume adjuster for adjusting volume of the audio signal.

3. The apparatus according to claim 2, wherein the volume adjusting module further comprises a controller for generating a volume adjusting signal to control the volume adjuster to adjust the volume of the audio signal.

4. The apparatus according to claim 1, further comprising a power supply for providing power for components among the apparatus.

5. The apparatus according to claim 1, further comprising an analog-to-digital converter for converting the compressed encoded audio signal from an analog format into a digital format to sent to the processor.

6. The apparatus according to claim 5, further comprising a digital-to-analog converter for converting the processed audio signal from the processor into an analog audio signal.

7. The apparatus circuit according to claim 6, further comprising an amplifier for amplifying the analog audio signal.

8. The apparatus according to claim 1, further comprising display module for displaying data of the compressed encoded audio signal.

9. The apparatus according to claim 1, wherein the processor adopts BBE technology as the sound effect processing technology to process the audio signal.

10. A method for reproducing digitized and compressed encoded audio data from a portable audio storage device, the method comprising the steps of:
reproducing a compressed encoded audio signals;
receiving the compressed encoded audio signal;
converting the compressed encoded audio signal from an analog format into a digital format;
processing the digital audio signal with a sound effect processing technology;
converting the processed audio signal into an analog audio signal;
adjusting volume of the analog audio signal;
outputting the adjusted audio signal.

11. The method according to claim 10, further comprising steps of:
collecting sound waves of environment;
identifying volume of the sound waves.

12. The method according to claim 11, further comprising step of:
generating a volume adjusting signal based on the volume of the sound waves;
adjusting the volume of the analog audio signal based on the volume adjusting signal;
amplifying the analog audio signal.

13. The method according to claim 11, further comprising a step of: amplifying the analog audio signal of the volume.

14. The method according to claim 10, further comprising a step of: displaying data of the audio signal.

15. The method according to claim 10, wherein BBE technology is used as the sound effect processing technology to process the digital audio signal.
